(19) United States
(12) Patent Application Publication
(10) Pub. No.: US 2007/0028046 A1
(43) Pub. Date: Feb. 1, 2007

(54) Flash device to external storage adapter

(75) Inventor: Chi Minh Pham, Lawndale, CA (US)

Correspondence Address: Min, Hsieh & Hack LLP;c/o PortfolioIP, P.O. Box 52050, Minneapolis, MN, 55402, US

(73) Assignee: Xerox Corporation

(21) Appl. No.: 11/191,079

(22) Filed: Jul. 28, 2005

(51) Int. Cl. G06F 12/00; G06F 13/14

(52) U.S. Cl. 711/115; 710/305

(57) ABSTRACT

Embodiments of the present invention provide an adapter that allows a Universal Serial Bus (USB) storage device to be connected into a port designed for a flash memory device. The adapter may connect to the USB storage device via a wired or wireless connection.

### DESCRIPTION OF THE EMBODIMENTS

1. Field

The present invention relates generally to an adapter between for a storage device. More particularly, the present invention relates to an adapter that allows an external device to be connected into a port for a memory device.

2. Background of the Related Art

Currently, a great variety of memory cards are available for electronic devices, such as digital cameras, personal digital assistants, mobile phones, video game consoles, and laptops. For example, flash memory cards are widely used as a convenient storage device for these devices.

Unfortunately, flash memory cards are relatively limited in amount of information they can hold. Users are often required to remove unwanted data from their flash memory cards or use multiple flash memory cards.

Typically, users will transfer the data from their flash memory cards to a larger storage device, such as the hard drive of a personal computer or a hard disk drive. However, this process can tedious and inconvenient to the users.

Therefore, it would be desirable to provide an apparatus or device that allows the user to easily connect a storage device to their device that uses flash memory.

### SUMMARY

An embodiment generally relates to an apparatus. The apparatus includes a first interface that is configured to connect to a port designed for a portable memory and a second interface that is configured to connect to an external bus standard port. The apparatus also includes a controller for transferring data between the first and second interfaces.

Another embodiment generally pertains to an adapter configured to connect an external storage device to a flash memory port of another device. The adapter includes a flash memory interface connecter that is configured to connect to the flash memory port and a USB interface that is configured to connect to the external storage device. The adapter also includes a controller configured to pass data between the external storage device and the other device.

Yet another embodiment relates generally to a system. The system includes a network and a storage device connected to the network. The system also includes an application device configured with a limited sized memory and an adapter configured to interface with the network and a port of the application device. The adapter is configured to transfer data between the application device and the storage device.

Additional features of some embodiments of the invention will be set forth in part in the description which follows, and in part will be obvious from the description, or may be learned by practice of the invention. The features of some embodiments of the invention can be realized and attained by the elements and combinations set forth in the appended claims.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate some embodiments of the invention and together with the description, may serve to explain the principles of the invention. In the figures:

FIG. 1 illustrates an exemplary system that is in accordance with embodiments of the present invention;

FIG. 2 illustrates an exemplary adapter that is in accordance with embodiments of the present invention; and

FIG. 3 illustrates another exemplary adapter that is in accordance with embodiments of the present invention.

### DESCRIPTION OF THE EMBODIMENTS

Embodiments generally relate to system and method of allowing the transfer of data from a first device to a second device, where the second device may be located in a remote location. More particularly, one embodiment relates to an adapter that allows a Universal Serial Bus (USB) storage device to be connected into a port designed for a flash memory device. Another embodiment pertains to an adapter that allows an IEEE 1394x storage device to interface with a flash memory device. The embodiments may connect to the first and second devices via a wired and/or wireless connection.

Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Reference will now be made in detail to some embodiments of the invention, which are illustrated in the accompanying drawings. Wherever possible, the same reference numbers will be used throughout the drawings to refer to the same or like parts. For simplicity and illustrative purposes, the principles of the present invention are described by referring mainly to exemplary embodiments thereof.

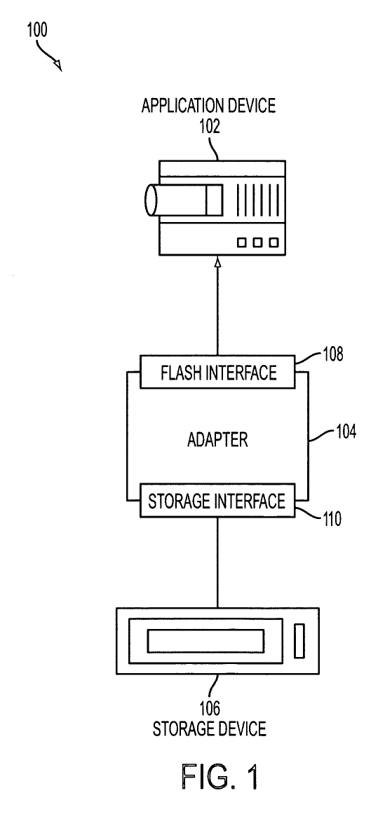

FIG. 1 illustrates an exemplary system 100 that is in accordance with an embodiment. As shown, system 100 may comprise an application device 102, an adapter 104, and a storage device 106.

Application device 102 may be any device that accepts a memory device, such as a flash memory device, e.g., Compacfflash, Secure Disk, memory stick, etc. For example, application device 102 may be a digital camera, video game console, laptop computer, mobile telephone, personal digital assistant, etc. Such devices are well known to those skilled in the art.

Adapter 104 serves an intermediary between application device 102 and storage device 106. For example, adapter 104 may allow external storage device 106 to be connected to the flash memory port of application device 102. Accordingly, adapter 104 may comprise a flash interface 108 and a storage interface 110.

In other embodiments, the adapter 104 may be configured to provide a wireless interface between the local memory of the application device 102 and a remote storage device 106. The remote storage device 106 may be accessible on a network, for example, a local area network, a wide area network, or some combination thereof. The wireless interface may be implemented using wireless protocols such as IEEE 802.11x, WiFiMax, Bluetooth or some similar protocol.

In one embodiment, flash interface 108 may comprise the components, such as hardware, software, and/or firmware, for connecting into the flash memory port of application device 102. Flash interface 108 may be configured for a wide variety of flash memory ports. For example, flash interface 108 may be compatible with the well known standards developed by the Personal Computer Memory Card International Association (PCMCIA), such as SmartMedia, Compact Flash, and PCMCIA Type I and II card ports. Accordingly, flash interface 108 may be implemented based on well known components of hardware, software, and/or firmware.

Storage interface 110 comprises the components for connecting adapter 104 to storage device 106. For example, in light of the prevalence of USB storage devices, some embodiments may implement storage interface 110 as a USB interface. For example, storage interface 110 may be implemented as a USB 2.0 interface, which is a well known standard developed by USB Implementers Forum. In other embodiments, the storage interface 110 may be implemented complying with the IEEE 1394x standard. It should be known to those skilled in the art that other external bus standards are contemplated in yet other embodiments.

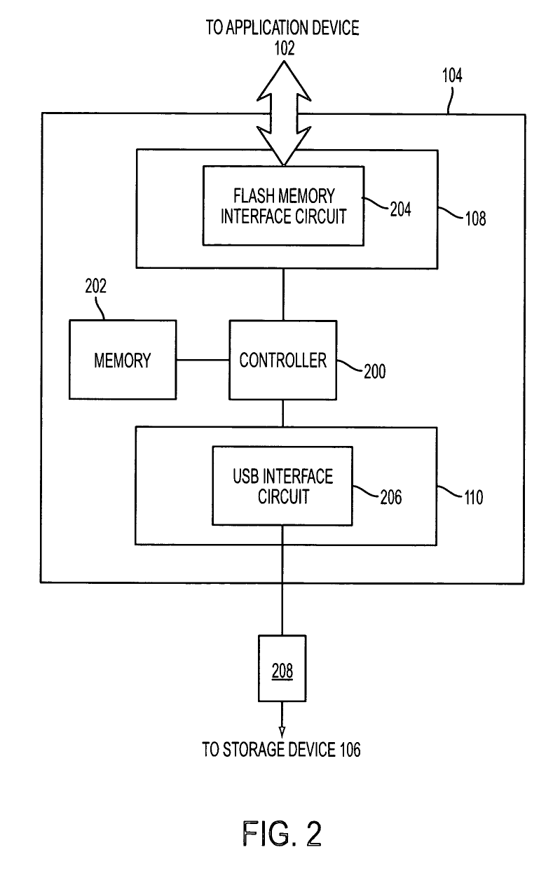

FIG. 2 illustrates an exemplary embodiment of adapter 104 that is in accordance with embodiments of the present invention. As shown, adapter 104 may comprise a controller 200 and a memory 202. In addition, in the embodiment shown, flash memory interface 108 may comprise a flash memory interface circuit 204 and storage interface 110 may comprise a USB interface, IEEE 1394x, ATA, SCSI, EIDE or other external bus standard interface circuit 206.

Controller 200 controls the operation of adapter 104. For example, controller 200 may perform various translations between changes in data format as data is transferred across adapter 104 in either direction. In addition, controller 200 may monitor flash memory interface circuit 204 and storage interface circuit 206 to determine when adapter 104 has been connected to either device alone or in combination. Controller 200 may also determine whether to lock or restrict when data is being overwritten by application device 102, for example, in storage device 106. Furthermore, controller 102 may provide one or more control signals that indicate the status of any connections between application device 102 or storage device 106, such as a set of light emitting diodes (not shown).

Memory 202 serves as an internal memory for adapter 104 while data is being read or written between application device 102 and storage device 106. For example, as data is being passed from application device 102 to storage device 106, controller 200 may buffer some or all of the data in memory 202. Other uses of memory 202 are also in accordance with the principles of the present invention. For example, memory 202 may serve as a cache for recently transferred items.

Memory 202 may be implemented using well known types of memory. For example, memory 202 may itself be a flash memory. In addition, memory 202 may be integrated as a permanent component of adapter 104 or may be a removable memory, such as a flash memory, and thus provide automatic translation to many different industry standard flash devices (SD, memory stick, MMC, etc...).

Flash memory interface circuit 204 comprises the circuitry for connecting to the flash memory port of application device 102. As noted, in some embodiments, circuit 204 may be compatible with a wide variety of flash memory ports, such as those adhering to the PCMCIA standards. Therefore, circuit 204 may be implemented using well known components. One skilled in the art should also recognize that adapter 104 may comprise multiple interface circuits 204. Thus, adapter 104 may be capable of connecting to a plurality of application devices 102, even if they use different flash memory card types.

The interface circuit 206 comprises the circuitry for connecting to a storage device, for example, USB disk drive, an IEEE 1394x disk drive, an ATA hard drive or other similar disk drive. Such circuitry is well known to those skilled in the art. In the embodiment shown, the interface circuit 206 is implemented as a wire line USB/Firewire interface. Accordingly, a USB/Firewire connector 208 may extend from USB/Firewire interface circuit 206. Such connectors are also well known to those skilled in the art.

One skilled in the art should also recognize that adapter 104 may support multiple USB/Firewire interfaces. Therefore, adapter 104 may connect to multiple storage devices, such as storage device 106.

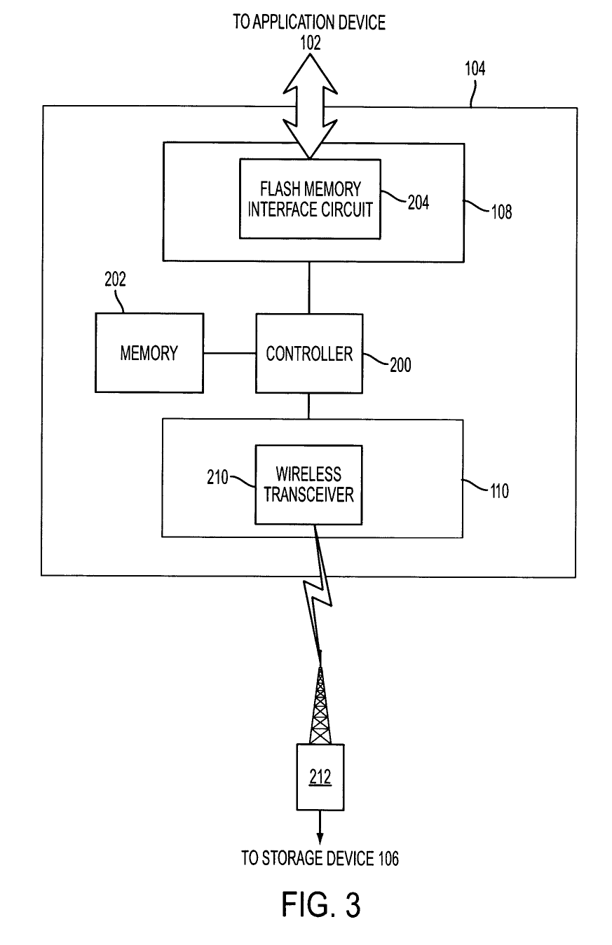

FIG. 3 illustrates another exemplary embodiment of adapter 104 that is in accordance with embodiments of the present invention. In this embodiment, adapter 104 utilizes a wireless interface to storage device 106. Accordingly, adapter 104 may employ a wireless transceiver 208 in storage interface 110.

Wireless transceiver 208 may support a variety of wireless protocols (Bluetooth, IEEE802.11AB/G, WiFiMax, or other similar protocol). For example, the 802.11 family of standards developed by IEEE (also known as “WiFi”) may be supported by wireless transceiver 208. One skilled in the art will recognize that, in this embodiment, a wireless USB adapter 212 may correspondingly be connected to external storage 106 in order to complete the wireless link. Wireless USB adapter 212 may conform to any wireless standard used by transceiver 208. One skilled in the art will also recognize that wireless USB adapter 212 may be implemented based on well known components.

It will be apparent to those skilled in the art that various modifications and variations can be made to the embodiments of the disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. An apparatus, comprising:
a first interface that is configured to connect to a port designed for a portable memory;
a second interface that is configured to connect to an external bus standard port; and
a controller for transferring data between the first and second interfaces.

2. The apparatus of claim 1, wherein the first interface is configured to connect to a port designed for a flash memory card.

3. The apparatus of claim 1, wherein the second interface comprises a wired connection to a USB port.

4. The apparatus of claim 1, wherein the second interface comprises a wired connection to an IEEE 1394x port.

5. The adapter of claim 1, wherein the second interface comprises a wireless transceiver that is compatible to a USB device.

6. The apparatus of claim 1, wherein the second interface comprises a wireless transceiver that is compatible to an IEEE 1394x device.

7. The apparatus of claim 1, wherein the second interface comprises a wireless transceiver that complies with one of IEEE 802.11x, WiFiMax and Bluetooth.

8. An adapter configured to connect an external storage device to a flash memory port of another device, said adapter comprising:
a flash memory interface connecter that is configured to connect to the flash memory port;
a USB interface that is configured to connect to the external storage device; and
a controller configured to pass data between the external storage device and the other device.

9. A system comprising:
a network;
a storage device connected to the network;
an application device configured with a limited sized memory; and
an adapter configured to interface with the network and a port of the application device, wherein the adapter is configured to transfer data between the application device and the storage device.

10. The system according to claim 9, wherein the limited sized memory comprises a flash memory.

11. The system according to claim 9, wherein the adapter is configured to interface with the network using a wired protocol.

12. The system according to claim 9, wherein the adapter is configured to interface with the network using a wireless protocol.

13. The system according to claim 12, wherein the wireless protocol is one of IEEE802.11x, Bluetooth and WiFiMax.

14. The system according to claim 9, wherein the storage device complies with one of universal serial bus, IEEE 1394x, SCSI, and EIDE.

15. The system according to claim 9, wherein the port is configured to be a flash memory port.

16. The system according to claim 9, wherein the network is a local area network.

17. The system according to claim 9, wherein the network is a wide area network.
